(19) United States
(12) Patent Application Publication
(10) Pub. No.: US 2002/0143418 A1
(43) Pub. Date: Oct. 3, 2002

(54) Product cost variance analysis system and control method of the same

(75) Inventors: Kazumasu Ohara, Nagoya-shi (JP); Yasunori Arai, Toyota-shi (JP); Akinori Yamada, Nishikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-Shi (JP)

(21) Appl. No.: 10/103,740

(22) Filed: Mar. 25, 2002

(30) Foreign Application Priority Data
Mar. 28, 2001 (JP) 2001-091704

(51) Int. Cl. G06F 19/00

(52) U.S. Cl. 700/95

(57) ABSTRACT

A product cost variance analysis system and method accurately calculates the cost of a product produced in a mixed production line, presents a factor of the cost variance in detail with accuracy, and provides information which can be effectively reflected in cost adjustment. Based on information integrally controlled in an integrated database, a target cost of a product is calculated and stored in the integrated database. Also, an actual cost of the product is calculated and stored in the integrated database. A difference between the target cost and the actual cost of the product is calculated and analyzed based on information from the integrated database. A variance for each item with difference by factor which is the cause of the difference is calculated, and then the results are displayed for each item respectively.

### INCORPORATION BY REFERENCE

The disclosure of Japanese Patent Application No. 2001-091704 filed on Mar. 28, 2001 including the specification, drawings, and abstract is incorporated herein by reference in its entirety.

### BACKGROUND OF THE INVENTION

1. Field of Invention

The invention relates to a product cost variance analysis system and method, and particularly to an improvement of a product cost variance analysis system and method which accurately analyzes in detail a cost variance of a product produced in a mixed production line which produces multiple types of products on a single production line.

2. Description of Related Art

A variety of cost calculations relating to products to be produced are carried out in product production plants and the like. One example is a cost calculation system which automatically calculates man-hours and the raw material volume required for production of a target product, a negotiated price of purchased parts, and the like for each product to be produced. Also, there is a cost calculation system which, if new products are produced, predicts the cost per new product by appropriately dividing man-hours and a raw material cost required for new products production based on the past production records of similar products. Furthermore, a cost calculation system is proposed that calculates a predicted cost by inputting newly changed production specifications, material weight and the like, and judges, based on the calculation results, whether or not a product is profitable.

General product production produces the same type of products in a single line, which is what is called homogeneous production. In homogeneous production, parts used in a product to be produced in a production line are the same. Therefore, a portion cost of a part (cost including man-hours, equipment cost, etc.) used in the production line can easily be calculated by dividing the cost required for the total production volume by the total production volume. Then, by using the portion cost calculated in the cost calculation system explained above, calculation related to the manufacturing cost can be performed easily.

The aforementioned cost calculation system, however, has the following problems. The first problem is that the cost to be calculated is a cost of a completed product. Therefore, if the cost thus calculated is utilized, the costs can only be compared between the products, and thus a factor causing increase or decrease of the cost in manufacturing the target product can not be actually identified. That is, the aforementioned cost calculation system can be utilized in judging whether or not the manufacturing specifications and the product are profitable. Nevertheless, there is also a further problem that, when adjusting (usually reducing) the cost of the target product, the precise part of a manufacturing activity against which measures should be taken can not be identified, and therefore the cost calculation results are not utilized effectively.

Meanwhile, an automobile production line and the like do not perform so-called homogenous production in which the same model is produced in a single production line but perform so-called mixed production in which various models are produced in a single production line. That is, different types of parts are processed or assembled for each product even in the same process. In such mixed production, man-hours required for processing or assembling parts of the same function vary, or different equipment and skills are required for processing and assembling. As a result, the cost required varies by product and therefore a part portion cost can not simply be calculated by dividing the required cost by the total production volume as in the case of the homogenous production, thereby presenting a problem that it is difficult even to calculate the cost of a completed product.

That is, there was a problem that even if the cost is calculated, calculation results can not be reflected in the production activity and efficient cost adjustment can not be performed.

### SUMMARY OF THE INVENTION

It is one object of the invention, in light of the problems described above, to provide a product cost variance analysis system and method which can accurately calculate the cost of a product to be produced in a mixed production line, accurately present a factor of variance of the cost in detail, and provide information which can effectively be reflected in cost adjustment.

In order to achieve the aforementioned and/or other objects, the product cost variance analysis system and method, which are aspects of the invention, for analyzing the product cost variance in the mixed production line calculates a target cost by calculating the cost of a certain part used on a product to be produced in the mixed production line based on components of the cost, and multiplying the cost and a coefficient of the certain part based on a mixture ratio of the mixed production line.

According to the above aspects of the invention, in the mixed production, what factor, namely item with difference by factor, in the production activity caused a component of the cost to be generated can be analyzed, and results thereof can be presented. That is, in cost adjustment, a producer of products can easily determine a factor against which measures should be taken based on the aforementioned results.

### BRIEF DESCRIPTION OF THE DRAWINGS

The invention will be described in detail with reference to the attached drawings in which like numerals represent like elements and wherein:

FIG. 1 is a block diagram which explains a configuration outline of a product cost variance analysis system according to an embodiment of the invention;

FIG. 2 is a schematic diagram which explains a configuration outline of an analysis module of the product cost variance analysis system according to the embodiment of the invention;

FIG. 3A,B are an explanatory drawing of an example of a tabulation report prepared by the product cost variance analysis system according to the embodiment of the invention; and

FIG. 4 is a flowchart showing a processing sequence according to the embodiment of the invention.

### DETAILED DESCRIPTION OF PREFERRED EMBODIMENTS

Hereinafter, a preferred, exemplary embodiment of the invention is explained referring to the drawings.

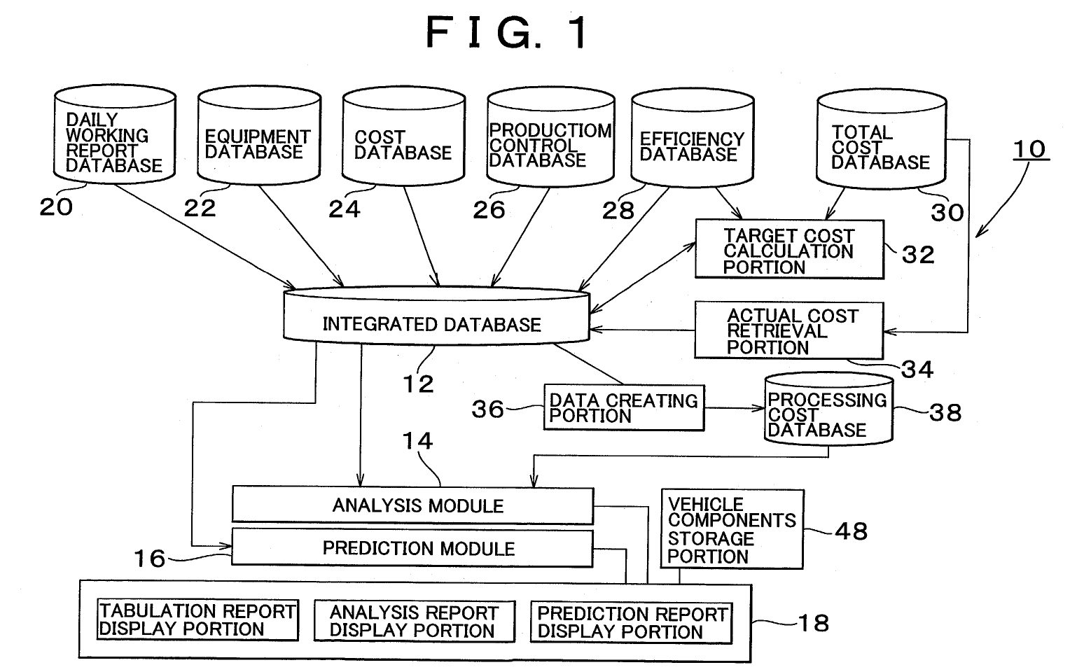

FIG. 1 is a block diagram explaining a configuration outline of a product cost variance analysis system (hereinafter referred to as “system”) 10. The system 10 according to the embodiment is mainly composed of an integrated database 12, an analysis module 14, a prediction module 16, a tabulation report display portion 18 and the like.

The integrated database 12 integrates various databases. The analysis module 14 retrieves necessary information from the integrated database 12 and analyzes the cost. The prediction module 16 retrieves necessary information from the integrated database 12 and predicts the cost. The tabulation report display portion 18 presents results of the analysis and the prediction in, for example, the form of a report. The report can be printed or transmitted electronically for display or printing.

The databases integrated by the integrated database 12 include, for example, a daily working report database 20, an equipment database 22, a cost database 24, a production control database 26, an efficiency database 28, a total cost database 30, and the like.

For example, the daily working report database 20 stores information relating to working conditions of each employee. For example, an attendance record, working hours information of work to which allowance is paid (such as midnight shift, shift-work and special work), employee status information (such as full-timer, part-timer, outworker, year the employee entered the company, and duty position), and other information are stored in database 20.

The equipment database 22 stores information relating to equipment used in a production line, etc. For example, an equipment introduction plan, budget, a plan progress status, a final expenditure, a department in which equipment is installed, a plan and record of maintenance-related cost, and other information are stored in database 22.

The cost database 24 stores a raw material cost estimate for each processing part number, actual cost data, and the like.

The production control database 26 stores information relating to a product production plan. For example, if the product is an automobile, a production plan for each vehicle model (specifications) is stored in database 26. For example, a production plan by vehicle name is stored for a long period (on a yearly basis for example) and a production plan by model (detailed specifications) is stored for a short period (on a monthly basis for example) in database 26. In addition, information such as a mixture ratio of the mixed production is stored in database 26.

The efficiency database 28 stores information relating to standard man-hours and actual man-hours for each product (part number) and process, specific production volume and the like. The efficiency database 28 also stores an efficiency calculation for each department with respect to the actual man-hours and the standard man-hours.

The total cost database 30 stores calculation data of actual cost according to department, part number, production site and division, reference specification data for itemizing expenditure data of each department, and other data which are obtained from financial data. For example, the cost required for production (such as labor cost, equipment cost, direct material cost, and operation cost (including energy cost and cost required for maintaining the actual company organization), records of cost actually required, and the like are stored in database 30.

These data are provided to the integrated database 12 to be comprehensively controlled, from which necessary information is retrieved as appropriate. In addition to the above, in the case of the mixed production to which the embodiment applies, for example, man-hours required for processing and handling a part (product), material cost, equipment used, and the like differ by size, weight, shape, etc. of the part (product) to be used. With these differences taken into account, a weighting coefficient is correlated with each part (product) and is stored in the integrated database 12.

The databases described above may be constructed independently as shown in FIG. 1 to be controlled comprehensively by the integrated database 12, or all data may be constructed and controlled in a single database.

The system 10 according to the embodiment is provided with a target cost calculation portion 32. The target cost calculation portion 32 calculates a target cost relating to a part (product) subjected to product cost variance analysis based on information from the total cost database 30 and the efficiency database 28 and various data stored in the integrated database 12. For example, the target cost calculation portion 32 obtains from the total cost database 30 information such as labor cost, equipment cost, direct material cost, operation cost of the target part (product), and also obtains standard man-hours information from the efficiency database 28 to calculate a processing cost rate of the target part (product). In addition, the target cost calculation portion 32 obtains the production volume of the target part (product) through the efficiency database 28 as well as the mixture ratio and the coefficient per part (product) from the integrated database 12 described above, and calculates a portion cost, which is what is called the target cost, of the target part (product) in the mixed production. Then, the target cost calculation portion 32 again stores the calculation results in a target cost storage area (target cost database) in the integrated database 12 according to each part number.

An actual cost retrieval portion 34 provided in the system 10 retrieves the actual cost required for a part (product) subjected to product cost variance analysis and obtains the actual cost. As explained earlier, the total cost database 30 stores the financial data. The financial data is stored in a condition such that, for example, the actual cost per part (product) or division is summed up. Therefore, the actual cost of the target part (product) is retrieved from the actual cost retrieval portion 34 and stored in an actual cost storage area (actual cost database) in the integrated database 12 according to each part number.

Furthermore, the system 10 according to the embodiment is provided with a data creating portion 36 which creates new processing data by using information stored in the integrated database 12. This portion creates a wage rate by processing information from the aforementioned databases 20 to 30 as well as a basic portion (standard portion) of the resource volume (such as required man-hours, and equipment and raw materials used), and stores them in a processing cost database 38.

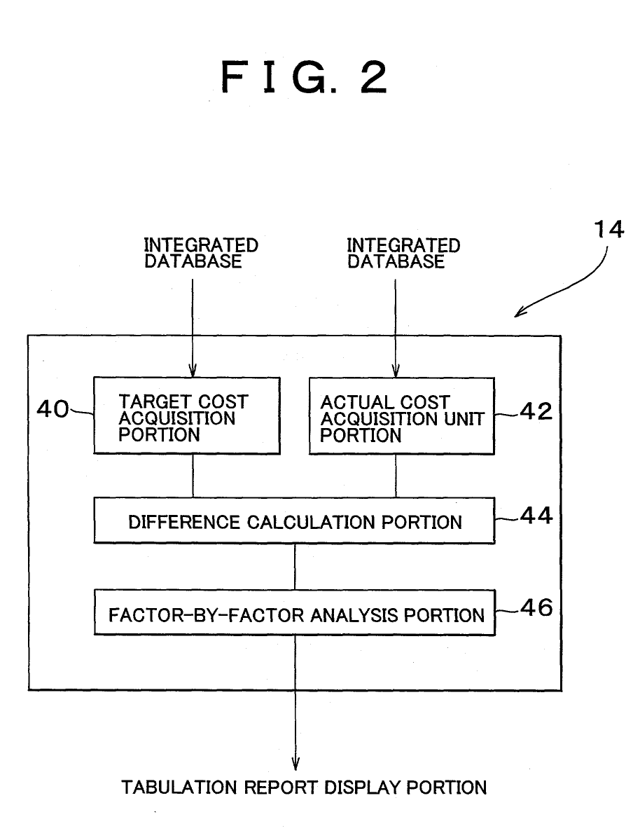

FIG. 2 illustrates an outline of an inside configuration of the analysis module 14 shown in FIG. 1. The analysis module 14 includes a target cost acquisition portion 40, an actual cost acquisition portion 42, a difference calculation portion 44, and a factor-by-factor analysis portion 46.

The target cost acquisition portion 40 obtains the target cost of a part (product) to be analyzed stored in the integrated database 12 and provides it to the difference calculation portion 44. Also, the actual cost acquisition portion 42 obtains the actual cost of the part (product) to be analyzed stored in the integrated database 12 and provides it to the difference calculation portion 44. The difference calculation portion 44 calculates a difference between the target cost, namely the cost estimated based on the existing data, and the actual cost, namely the cost required for actual production, to determine the actual cost variance. Furthermore, referring to results thus obtained, the factor-by-factor analysis portion 46 analyzes a variance in each specific item and provides the analysis results to the tabulation report display portion 18 (refer to FIG. 1).

The factor-by-factor analysis portion 46 analyzes in detail, each item, among items for which the aforementioned difference between target cost and actual cost is calculated, related to at least “material cost” and “labor cost” in a major variable cost which is a main factor of the cost variance. In other words, analysis is performed on each item with difference by factor. The item with difference by factor is predetermined and, for example in the case of the raw material cost, the item will be “wage rate variance” and “basic portion variance”. The wage rate variance is the variance of a purchasing portion cost per weight or volume of the raw material. Also, in the case of the labor cost, analysis is performed on such items as “wage rate variance” representing the variance of a wage paid per man-hour, “efficiency influence” representing cost influence due to a man-hours difference per production volume, and “indirect labor cost” representing increase and decrease of the labor cost in a non-manufacturing department (such as a managerial function).

In addition, another factor of the cost variance is “fixed cost”. The fixed cost includes “particular expenses”, “depreciation cost”, “expenditure”, “plant-assistant division cost” and the like. The particular expenses can be itemized into “production variance” representing an increase/decrease influence of production variance and “cost increase/decrease” representing an influence of increase/decrease of the cost required. Similarly, the depreciation cost, expenditures, plant-assistant division cost, and the like respectively include “production variance” representing an increase/decrease influence of production variance and “cost increase/decrease” representing an influence of increase/decrease of the cost required.

A value indicated for each item with difference by factor is calculated by re-calculating a cost variance which is the cause of a difference between the target cost and the actual cost, based on information in the integrated database 12. In other words, the value for each item with difference by factor is calculated by analyzing a balance between the production volume and the resource volume required for production. The resource volume represents a physical input of materials and equipment required for production, such as man-hours and equipment and raw materials used. For example, in the labor cost representing man-hours which is one type of resource volume, if there is a difference of L yen between the target cost and the actual cost, the cause of the difference is the variance in each factor of the “wage rate variance”, “efficiency influence”, and “indirect labor cost”. Accordingly, by measuring a variance in each factor, the degree of an influence of such variance on a value can be indicated. For instance, in the case of a wage rate variance of 1%, an influence of the 1% variance on a value of a product is calculated. Similarly, a variance is measured for each factor with respect to the raw material cost and the fixed cost, and corresponding values are calculated. By doing so, with respect to the difference between target cost and actual cost, the influence of each variance on cost can be easily recognized.

When creating a tabulation report in the tabulation report display portion 18, for a correlation with a completed product which is a vehicle, information from a vehicle components storage portion 48 representing components (parts) of a completed product (vehicle) is utilized.

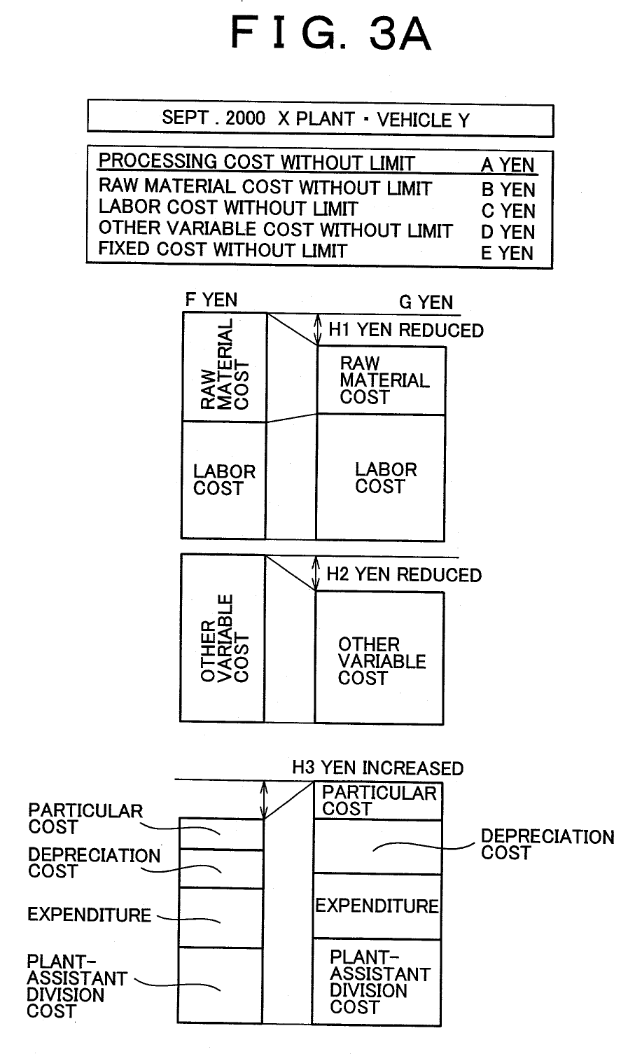

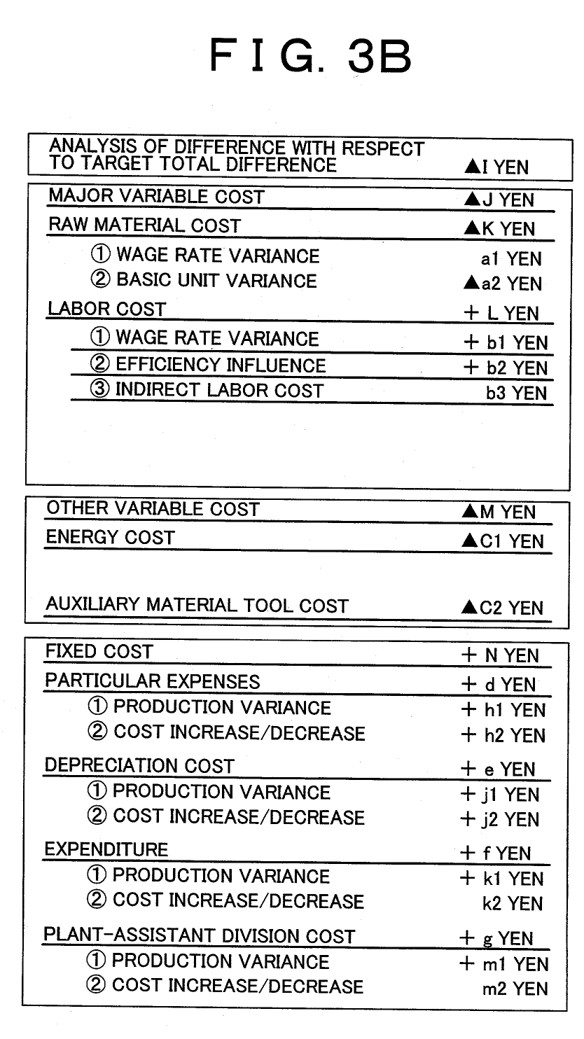

FIG. 3A and B show an example of a tabulation report displayed by the tabulation report display portion 18. The tabulation report shows results of cost variance analysis performed on a vehicle Y at X plant in September 2000. The upper portion of Fig.3A shows the cost (value) expected to be required in production of the vehicle Y, which is to be represented as “processing cost without limit”. A breakdown of the processing cost without limit is listed as “raw material cost without limit”, “labor cost without limit”, “other variable cost without limit”, “fixed cost without limit” and the like. These costs are calculated using the past data of the same model or a similar model.

Also, under the listing of the costs without limit, a variance between the target cost (shown by a narrow bar on the left) and the actual cost (shown by a wide bar on the right) is shown. The results of comparison of the target cost and the actual cost are classified and indicated as a major variable cost in the upper graph, an other variable cost in the middle graph, and a fixed cost in the lower graph. The major variable cost in the upper graph is classified into components of “raw material cost” and “labor cost” to be indicated. The fixed cost in the lower graph is classified into components of “particular expenses”, “depreciation cost”, “expenditure”, and “plant-assistant division cost” to be indicated. These components can be indicated easily by referring to the financial data and the like provided to the integrated database 12. The example in FIG. 3A and B show that the actual cost is “reduced by H1 yen” with respect to the target cost concerning the major variable cost, the actual cost is “reduced by H2 yen” with respect to the target cost concerning the other variable cost, and the actual cost is “increased (target not achieved) by H3 yen” with respect to the target cost concerning the fixed cost.

The FIG. 3B is a listing part which is a feature of the embodiment, and shows a total cost difference I yen (target cost F−actual cost G) in the upper column. Under this column, a major variable cost J, an other variable cost M, and a fixed cost N are indicated respectively. As described above, “wage rate variance” and “basic portion variance” are calculated with respect to the “material cost”, and “wage rate variance”, “efficiency influence”, and “indirect labor cost” are calculated with respect to the “labor cost”. Furthermore, under the “other variable cost”, “energy cost” and “auxiliary material tool cost”, for example, are calculated. Similarly, “production variance” and “cost increase/decrease” are respectively calculated with respect to each of “particular expenses”, “depreciation cost”, “expenditure”, and “plant-assistant division cost” under the “fixed cost”.

As explained above, when there is a difference between the target cost and the actual cost, a breakdown of the difference is shown as the absolute value for each factor. Therefore, conventionally, only a difference between the target cost and the actual cost is indicated, if any, and thus the cause of the difference was unclear. However, by presenting a tabulation report as shown in FIG. 3A and B, it can be easily and accurately recognized which variances have how much influence on the cost variance. For example, when there is a difference of 50 yen between the target cost and the actual cost, and if the difference is indicated in the item of “wage rate variance”, it can be recognized that the difference is “caused by the wage rate variance”. Also, if the difference is indicated in the item of “production variance”, the cause can be easily recognized such as “the difference is caused by a variance in the depreciation cost of equipment due to the production variance”. Additionally, appropriate measures can be taken against the cause and an efficient and optimum feedback can be given for cost adjustment.

The item with difference by factor described above are only some examples. Thus, the labor cost etc., for example, can further be itemized into “paid wage variance”, “overtime work”, “temporary employees”, “attendance rate”, “operation days” and the like. The itemized items also can be analyzed by selecting information from the integrated database 12 as appropriate, enabling a further appropriate cost variance analysis.

Meanwhile, the system 10 according to the embodiment is also capable of predicting the cost in the prediction module 16 by using information from the integrated database 12. That is, the degree of possible wage variance can be calculated by providing the prediction module 16 with a production plan of a certain product, the resource volume that can be input, information of certain parts composing the certain product (product components). Similarly, a variance in the depreciation cost under the fixed cost can be calculated. As explained above, by calculating back a value variance for an item with difference by factor, and summing up results thereof, the cost when the certain product is produced under desired conditions can be predicted.

Furthermore, for example, the staff distribution and work shifts that allow the achievement of cost reduction and the performance of an efficient production activity can be simulated easily.

The configuration of the system 10 according to the embodiment is one example. Accordingly, as long as the configuration is such that a difference between the target cost and the actual cost is calculated, and each item with difference by factor which is the cause of the difference is individually analyzed and represented, the configuration of the databases or modules are not limited and the same effect as in the embodiment can be obtained even if the configuration is changed as appropriate. Also, the system 10 in FIG. 1 shows an general idea of the configuration and it may be configured by, for example, a single system mainly composed of a computer.

The tabulation report shown in FIG. 3A and B also are an example, and thus various items may be added or deleted as appropriate and/or the layout of the report may be changed. Furthermore, a representation form of the tabulation report is not limited, and, for example, it may be represented on a display or it may be printed on a predetermined sheet. Also, FIG. 3A and B show the report of the cost analysis performed on the vehicle Y, however, for instance, the cost analysis on intermediate parts composing the vehicle Y may also be performed in the same manner as in the aforementioned embodiment, and the same effect can be obtained. In particular, the cost analysis for an intermediate manufacturing plant and an intermediate manufacturing process in which the intermediate parts are manufactured can be performed easily and accurately.

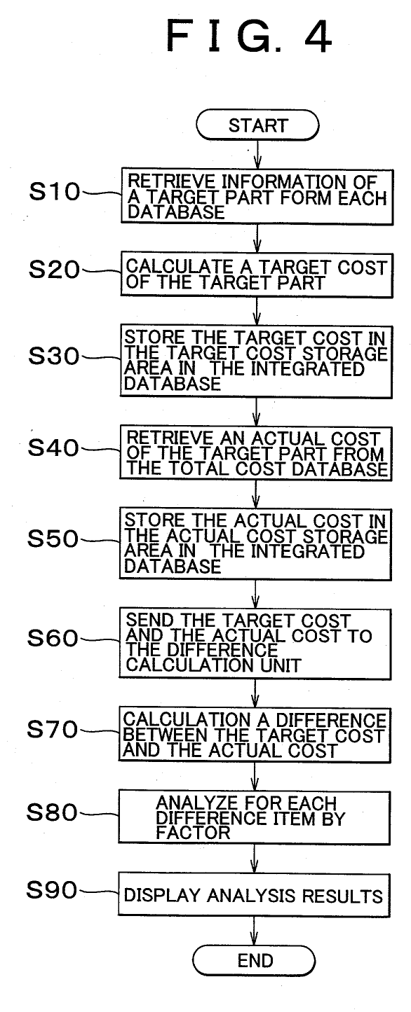

A flow of processing according to the aforementioned embodiment is explained referring to FIG. 4.

First in S10, the target cost calculation portion 32 retrieves from each database 12, 28, 30 information of a target part subjected to cost calculation. Then, the target cost calculation portion 32 calculates the target cost of the target part in S20. The target cost thus calculated is stored in the actual cost storage area in the integrated database 12 in S30. Next, in S40, the actual cost calculation portion 34 retrieves the actual cost of the target part from the total cost database 30. Then, the actual cost thus retrieved is stored in the actual cost storage area in the integrated database 12 in S50. In S60, the target cost and the actual cost are obtained from the integrated database 12 by the target cost acquisition portion 40 and the actual cost acquisition portion 42 respectively, and sent to the difference calculation portion 44. In S70, the difference calculation portion 44 calculates a difference between the target cost and the actual cost. Then, in S80, the factor-by-factor analysis portion 46 performs analysis on each item with difference by factor. In S90, each item analyzed in S80 is displayed, and this completes a series of processing.

By calculating the sum of all of the individual target cost of all products of the same kinds which are produced in the production line as a total cost of that one kind of product rather than calculating the target cost of one product, it is possible to control the target cost of the product by section, department, factory and so on.

According to the invention, in mixed production, the target cost and the actual cost are calculated easily and, in addition, an analysis is performed to determine which factor in the production activity, namely which item with difference by factor, caused a difference between the two costs, and the results thereof can be represented. In other words, a producer of products can, based on the results, easily determine, in adjusting the cost, what measures should be taken to which item.

In the illustrated embodiment, a controller (elements 14-18 and 32-36) is implemented as a programmed general purpose computer. It will be appreciated by those skilled in the art that the controller can be implemented using a single special purpose integrated circuit (e.g., ASIC) having a main or central processor section for overall, system-level control, and separate sections dedicated to performing various different specific computations, functions and other processes under control of the central processor section. The controller also can be a plurality of separate dedicated or programmable integrated or other electronic circuits or devices (e.g., hardwired electronic or logic circuits such as discrete element circuits, or programmable logic devices such as PLDs, PLAs, PALs or the like). The controller can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controller. A distributed processing architecture can be used for maximum data/signal processing capability and speed.

While the invention has been described with reference to preferred embodiments thereof, it is to be understood that the present invention is not limited to the disclosed embodiments or constructions. On the contrary, the present invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the present invention.

What is claimed is:

1. A product cost variance analysis system that analyze a product cost variance in a mixed production line which produces a plurality of kinds of products by assembling a plurality of certain parts in a single production line, comprising:
a controller that calculates a cost of the certain part used for a product produced in the mixed production line based on components of the cost, and calculates a target cost by multiplying the cost by a coefficient of the certain part based on a mixture ratio of the mixed production line.

2. The product cost variance analysis system according to claim 1, wherein the component of the cost includes at least a production volume, a labor cost, an equipment cost, a direct material cost, and an operation cost for the product.

3. The product cost variance analysis system according to claim 1, wherein the coefficient is a weighting coefficient which is set taking into account at least one of a material cost of the certain part, man-hours required for handling the certain part, and equipment used for the certain part.

4. The product cost variance analysis system according to claim 1, wherein the controller:
calculates an actual cost of the certain part;
determines a difference between the target cost and the actual cost and analyzes the difference with respect to each item with difference by factor; and
provides a readable representation of a result of the analysis.

5. The product cost variance analysis system according to claim 4, wherein the factor includes at least a raw material cost, a labor cost, and a fixed cost.

6. The product cost variance analysis system according to claim 5, wherein the raw material cost includes at least one of a wage rate variance and a basic portion variance as the item with difference by factor.

7. The product cost variance analysis system according to claim 5, wherein the labor cost includes at least one of a wage rate variance, an efficiency influence, and an indirect labor cost as the item with difference by factor.

8. The product cost variance analysis system according to claim 5, wherein the fixed cost includes at least one of particular expenses, a depreciation cost, an expenditure, and a plant-assistant division cost as the item with difference by factor.

9. The product cost variance analysis system according to claim 5, further comprising:
a total cost database in which information of the production volume, the labor cost, the equipment cost, the direct material cost, and the operation cost is stored;
an efficiency database in which at least information of standard man-hours and actual man-hours for each process with respect to the product is stored; and
an integrated database in which the total cost database and the efficiency database are comprehensively controlled and the coefficient is stored.

10. The product cost variance analysis system according to claim 9, wherein the controller obtains from the total cost database information of labor cost, equipment cost, direct material cost, operation cost of the target product, and obtain from the integrated database information of the coefficient per product, and calculates the target cost by multiplying the cost based on the labor cost, equipment cost, direct material cost, operation cost by the coefficient

11. The product cost variance analysis system according to claim 4, wherein the controller predicts a cost variance in the item with difference by factor based on at least one of a production plan for the product, a resource volume which can be input to the production line, and information of the certain part composing the product.

12. The product cost variance analysis system according to claim 4, further comprising:
a display monitor on which the readable representation of the result is displayed.

13. The product cost variance analysis system according to claim 4, further comprising:
a printer that prints the readable representation of the result.

14. The product cost variance analysis system according to claim 1, wherein
the product is an automobile and the certain part is a part composing the automobile.

15. The product cost variance analysis system according to claim 1, wherein
the controller calculates a sum of all of an individual target cost of all products of the same kinds which are produced in the production line as a total cost of that one kind of product.

16. A product cost variance analysis method which analyzes a product cost variance in a mixed production line, comprising the step of:
calculating a target cost by calculating a cost of a certain part used for a product produced in the mixed production line based on a component of the cost, and multiplying the cost with a coefficient of the certain part based on a mixture ratio of the mixed production line.

17. The method according to claim 16, wherein the component of the cost includes at least a production volume, a labor cost, an equipment cost, a direct material cost, and an operation cost for the product.

18. The method according to claim 16, wherein the coefficient is a weighting coefficient which is set taking into account at least one of a material cost of the certain part, man-hours required for handling the certain part, and equipment used for the certain part.

19. The method according to claim 16, further comprising the steps of:
calculating an actual cost of the certain part;
determining a difference between the target cost and the actual cost and analyzing the difference with respect to each item with difference by factor; and
displaying a result of the analysis.

20. The method according to claim 19, wherein the factor includes at least a raw material cost, a labor cost, and a fixed cost.

21. The method according to claim 20, wherein the raw material cost includes at least one of a wage rate variance and a basic portion variance as the item with difference by factor.

22. The method according to claim 20, wherein the labor cost includes at least one of a wage rate variance, an efficiency influence, and an indirect labor cost as the item with difference by factor.

23. The method according to claim 20, wherein the fixed cost includes at least one of particular expenses, a depreciation cost, an expenditure, and a plant-assistant division cost as the item with difference by factor.

24. The method according to claim 20, further comprising the steps of:
storing in a total cost database information of the production volume, the labor cost, the equipment cost, the direct material cost, and the operation cost;
storing in an efficiency database at least information of standard man-hours and actual man-hours for each process with respect to the product and
comprehensively controlling each of the information and storing of the coefficient in an integrated database.

25. The method according to claim 24, wherein further comprising the steps of: calculating the target cost by multiplying the cost based on the labor cost, equipment cost, direct material cost, operation cost by the coefficient

26. The method according to claim 19, further comprising the step of:
predicting a cost variance in the item with difference by factor based on at least one of a production plan for the product, a resource volume which can be input to the production line, and information of the certain part composing the product.

27. The method according to claim 19, wherein the result is displayed on a display.

28. The method according to claim 19, wherein the result is displayed by a printer.

29. The method according to claim 16, wherein the product is an automobile and the certain part is a part composing the automobile.

30. The method according to claim 16, wherein the controller calculates a sum of all of an individual target cost of all products of the same kinds which are produced in the production line as a total cost of that one kind of product.
